(19) United States
(12) Patent Application Publication
(10) Pub. No.: US 2026/0126156 A1
(43) Pub. Date: May 7, 2026

(54) LIGHT FIXTURE ASSEMBLY, LIGHT FIXTURE SYSTEM AND LIGHT FIXTURE MODULE

(71) Applicant: SAVANT TECHNOLOGIES LLC, East Cleveland, OH (US)

(72) Inventors: Huisheng ZHOU, Shanghai (CN); Xiao MIAO, Shanghai (CN); Hai HUANG, Shanghai (CN)

(73) Assignee: SAVANT TECHNOLOGIES LLC, East Cleveland, OH (US)

(21) Appl. No.: 19/259,812

(22) Filed: Jul. 3, 2025

(30) Foreign Application Priority Data
Jul. 30, 2024 (CN) 2024218339298

(51) Int. Cl. F21S 8/06

(52) U.S. Cl. CPC F21S 8/06; F21V 17/007

(57) ABSTRACT

Provided is a light fixture assembly that includes a light fixture housing and a light-emitting component, the light fixture housing is switchable between an assembled state and a transportation state; in the assembled state, a first end of a first housing component and a second end of a second housing component are fixed together, and the light-emitting component is received in accommodating space; and in the transportation state, the first housing component and the second housing component are stacked one on top of the other, and one of the first housing component and the second housing component is received in the accommodating space of the other of the first housing component and the second housing component. The present application further discloses a light fixture system and a light fixture module. Thus, a light fixture form which facilitates assembly and disassembly and transportation is provided.

### CROSS-REFERENCE TO RELATED APPLICATIONS

This application claims priority to Chinese Patent Application Serial Number 2024218339298, filed Jul. 30, 2024, which is herein incorporated by reference.

### TECHNICAL FIELD

The present application relates to a light fixture assembly, a light fixture system and a light fixture module.

### BACKGROUND

Generally, a light fixture assembly comprises a light fixture housing and a light-emitting component which are removably connected together. In a common light fixture assembly, the light fixture housing is generally integrally formed and has a large volume, such that it is difficult for a user to mount, and a large amount of space is required for transportation.

### SUMMARY OF THE INVENTION

In order to overcome the described defects existing in the prior art, the present application provides a light fixture assembly, comprising: a light fixture housing; and a light-emitting component being removably connected to the light fixture housing, wherein the light fixture housing comprises a first housing component and a second housing component that are detachably connected to each other, each of the first housing component and the second housing component extends along a longitudinal direction and has an open accommodating space; the light fixture housing is configured to be switchable between an assembled state and a transportation state; in the assembled state, a first end of the first housing component along the longitudinal direction and a second end of the second housing component along the longitudinal direction are fixed together, and the light-emitting component is received in the accommodating spaces of the first housing component and the second housing component; and in the transportation state, the first housing component and the second housing component are stacked one on top of the other, and one of the first housing component and the second housing component is at least partially received in the accommodating space of the other of the first housing component and the second housing component. Accordingly, this can facilitate assembly and disassembly of the light fixture assembly by a user and facilitate transportation of the light fixture assembly at a low cost.

Further, each of the first housing component and the second housing component comprises a top wall and two side walls extending from two opposite side edges of the top wall in a transverse direction perpendicular to the longitudinal direction, the top wall and the two side walls enclosing the accommodating space; wherein the cross section perpendicular to the longitudinal direction of each of the first housing component and the second housing component has a trapezoidal shape. Accordingly, more convenient stacking of the housing components and smaller footprint can be achieved.

Further, the first end of the first housing component is provided with a female end connecting portion, and the second end of the second housing component is provided with a male end connecting portion; wherein the male end connecting portion of the second housing component can be inserted into and connected to the female end connecting portion of the first housing component, such that the first housing component and the second housing component are fixed together. Accordingly, simple assembly of the light fixture housing can be achieved.

Further, each of the male end connecting portion of the second housing component and the female end connecting portion of the first housing component is provided with at least one insertion hole group; wherein in the assembled state, the insertion hole group of the female end connecting portion of the first housing component and the corresponding insertion hole group of the male end connecting portion of the second housing component are aligned for receiving a fixing component, the fixing component being inserted into the insertion hole group and the corresponding insertion hole group. Accordingly, the light fixture housing can be assembled more firmly.

Further, the light fixture housing further comprises at least one middle housing component for adapting to light-emitting components with different lengths. Accordingly, the light fixture housing can have different lengths, thereby improving the adaptability to light-emitting components with different lengths.

Further, the middle housing component extends along the longitudinal direction, and comprises a top wall and two side walls extending from two opposite side edges of the top wall of the middle housing component in the transverse direction, the top wall and the two side walls of the middle housing component enclosing an accommodating space; wherein the cross section perpendicular to the longitudinal direction of the middle housing component has a trapezoidal shape. Further, in the assembled state, the at least one middle housing component is fixed between the first housing component and the second housing component; and in the transportation state, the at least one middle housing component is stacked together with the first housing component and the second housing component. Accordingly, more convenient stacking of the housing components and smaller footprint can be achieved.

Further, the light fixture housing comprises a plurality of middle housing components, and in the assembled state, the plurality of the middle housing components are connected to one other in an end-to-end manner along the longitudinal direction. Accordingly, convenient assembly and length adjustment of the light fixture housing can be achieved.

Further, both ends of each middle housing component in the longitudinal direction are respectively provided with a male end connecting portion and a female end connecting portion; wherein the male end connecting portion of the middle housing component is configured to be capable of fitting with the female end connecting portion of an adjacent middle housing component or fitting with the female end connecting portion of the first housing component; and the female end connecting portion of the middle housing component is configured to be capable of fitting with the male end connecting portion of an adjacent middle housing component or fitting with the male end connecting portion of the second housing component. Accordingly, the light fixture housing can be assembled more simply and firmly.

Further, the light fixture assembly further comprises two suspension cable units; each suspension cable unit comprises a suspension cable and a hook portion connected at the bottom end of the suspension cable; each of a second end of the first housing component along the longitudinal direction and a first end of the second housing component along the longitudinal direction is provided with a hook hole group for fitting with respective hook portion. Accordingly, this can facilitate mounting of the light fixture assembly.

Further, each hook portion comprises two hooks; and each hook hole group comprises two hook holes spaced apart along the transverse direction. Accordingly, the hoisting of the light fixture assembly can be more stable.

Further, the light-emitting component comprises at least one light tube extending along the longitudinal direction.

Further, the light fixture assembly further comprises an end cap unit, the end cap unit comprising two end caps; the two end caps are fixed respectively at the second end of the first housing component along the longitudinal direction and the first end of the second housing component along the longitudinal direction, and are located in the accommodating spaces of the first housing component and the second housing component; each end cap comprises an end cap body, and at least one socket portion fixed on the end cap body and for receiving and being electrically connected to two plugs provided at one end of the light tube; wherein the end cap unit is configured to selectively allow one or both of the two plugs fitting with one end cap of the two end caps to be connected to a live wire, and the end cap unit is configured to allow two plugs fitting with the other end cap of the two end caps to be connected to a null wire.

Further, the end cap unit further comprises a switch provided on the one end cap, the switch being configured to be switchable between a first position and a second position; when the switch is located at the first position, both the two plugs fitting with the one end cap are connected to the live wire; and when the switch is located at the second position, one of the two plugs fitting with the one end cap is connected to the null wire and the other is connected to the live wire. Accordingly, this can improve the adaptability of the light fixture assembly.

The present application further provides a light fixture system, comprising: a plurality of light fixture assemblies, the plurality of light fixture assemblies being arranged side by side along a transverse direction; and two connecting plates extending along the transverse direction, wherein one of the two connecting plates connects the first housing components of the plurality of light fixture assemblies together, and the other of the two connecting plates connects the second housing components of the plurality of light fixture assemblies together. Accordingly, application of the light fixture assembly can be extended.

Further, the light fixture system further comprises a plurality of suspension cable unit groups, each suspension cable unit group comprising two suspension cable units; each suspension cable unit comprises a suspension cable and a hook portion connected at the bottom end of the suspension cable, and each hook portion comprising two hooks; wherein each of a second end of the first housing component along a longitudinal direction and a first end of the second housing component along the longitudinal direction is provided with a hook hole group, each hook hole group comprising two hook holes spaced apart along the transverse direction; wherein each connecting plate is provided with at least one pass-through hole group, each pass-through hole group comprising two pass-through holes; wherein the number of the suspension cable unit groups is the same as the number of the pass-through hole groups, and is one less than the number of the light fixture assemblies; and wherein one hook of the two hooks of the hook portion of each suspension cable unit is configured to be capable of passing through one pass-through hole of the pass-through hole group and then being hooked to one hook hole of the two hook holes of the hook hole group of the first housing component or the second housing component of the light fixture assembly; and the other hook of the two hooks of the hook portion of each suspension cable unit is configured to be capable of passing through the other pass-through hole of the pass-through hole group and then being hooked to one hook hole of the two hook holes of the hook hole group of the first housing component or the second housing component of an adjacent light fixture assembly. Accordingly, this can achieve secure assembly at a low cost.

The present application further provides a light fixture module, comprising: a housing unit extending in a longitudinal direction, and having an open accommodating space; and a light-emitting unit being removably connected to the housing unit; wherein the light fixture module is configured to be switchable between an assembled state and a transportation state; in the assembled state, the light fixture module is connected together with other light fixture modules along the longitudinal direction and/or a transverse direction, and the light-emitting unit is received in the accommodating space of the housing unit and electrically connected to the light-emitting unit of the other light fixture module; and in the transportation state, the housing unit of the light fixture module and the housing units of the other light fixture modules are stacked one on top of the other, and the housing unit of the light fixture module is received in the accommodating space of the housing unit of the other light fixture module. Accordingly, a light fixture form which facilitates assembly and disassembly by a user and facilitates transportation is provided.

### BRIEF DESCRIPTION OF THE DRAWINGS

Drawings are used for providing further understanding of the present application and constitute a part of the present application, and the illustrative embodiments of the present application and illustrations thereof are used for explaining the present application, rather than constitute inappropriate limitation on the present application. In the drawings:

FIG. 1 is a schematic perspective view showing a light fixture assembly according to the present application in an assembled state;

FIG. 2 is a schematic exploded view showing the light fixture assembly as shown in FIG. 1;

FIG. 3 is a schematic perspective view showing a part of a light fixture assembly according to the present application in a transportation state;

FIGS. 4A-4D schematically show an assembly process of a first housing component and a second housing component of the light fixture assembly as shown in FIG. 1;

FIG. 5 schematically shows three exemplary assembly forms of the light fixture assembly of the present application;

FIG. 6A is a bottom perspective view showing a part of the light fixture assembly as shown in FIG. 1;

FIG. 6B is a schematic circuit diagram of a light fixture assembly when a switch is in a first position;

FIG. 6C is a schematic circuit diagram of a light fixture assembly when a switch is in a second position;

FIG. 7A is a schematic exploded view showing a part of a light fixture assembly according to one embodiment;

FIG. 7B is a schematic exploded view showing a part of a light fixture assembly according to another embodiment;

FIG. 8 is a schematic perspective view illustrating a light fixture system according to the present application;

FIG. 9 is a schematic exploded view showing the light fixture system as shown in FIG. 8; and

FIG. 10 is a schematic exploded view showing a light fixture module according to the present application.

### DETAILED DESCRIPTION

Hereinafter, the technical solutions in the embodiments of the present application will be described in detail with reference to the accompanying drawings in the embodiments of the present application. It should be noted that the embodiments in the present application and features in the embodiments can be combined with each other without conflicts.

In the following detailed illustration, reference is made to the accompanying drawings which form a part of the present description, in which specific embodiments which can implement the present application are shown by way of illustration. With regard to the drawings, directional terms, such as “top”, “bottom”, “inner”, “outer”, “upper”, “lower”, “front”, “rear”, and the like, are used with reference to the directions of the drawings as described. As assemblies of embodiments of the present application may be placed in many different directions, the directional terms are used for purposes of illustration only, and are not intended for limiting. It is to be understood that other embodiments may be used, and structural or logical changes may be made without departing from the scope of the present application. Therefore, the following detailed illustration should not be understood as limiting, and the present application is defined by the appended claims.

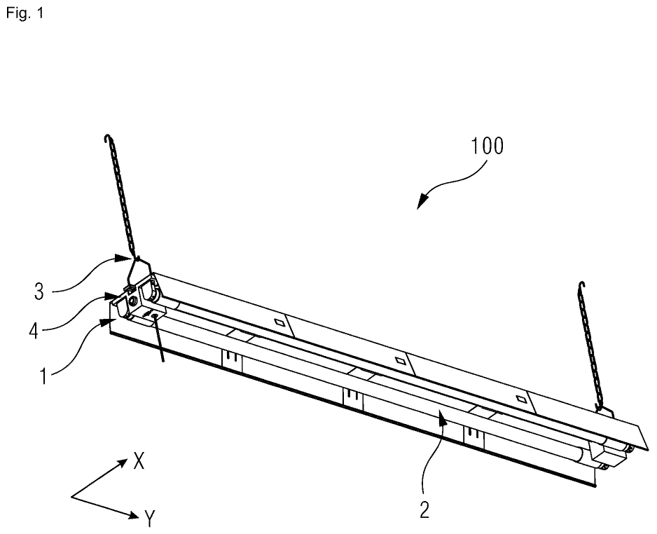

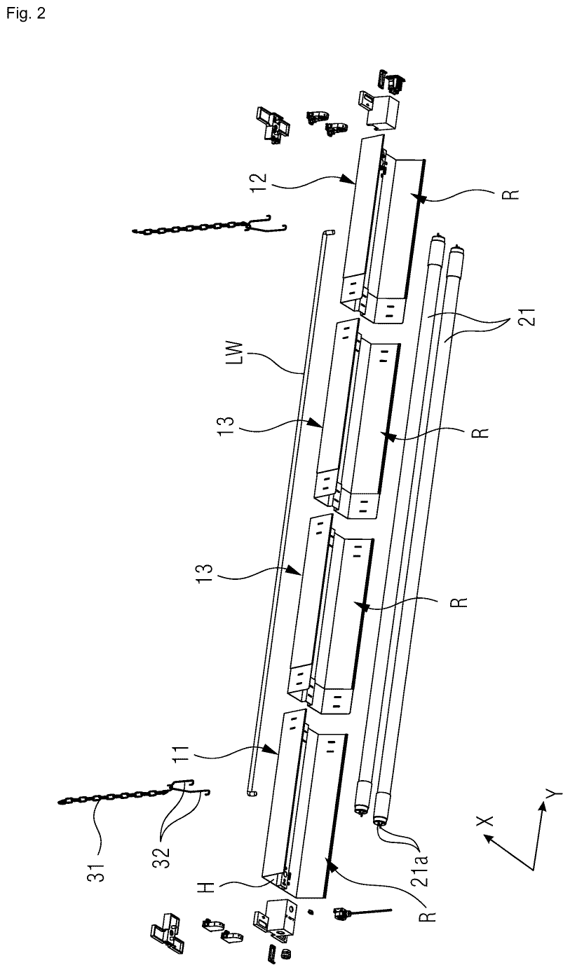

Refer to FIGS. 1-7B, the present application proposes a light fixture assembly 100. The light fixture assembly 100 may generally comprise a light fixture housing 1 and a light-emitting component 2 removably connected to the light fixture housing 1. For example, the light fixture assembly 100 of the present application can be connected to the ceiling or wall of a house, such as being hung on the ceiling by suspension cable units 3 described in detail below. Of course, the present application is not limited thereto, and other connection structures other than the suspension cable units 3 can also be used to mount the light fixture assembly on the ceiling or the wall.

The light fixture housing 1 may comprise a first housing component 11 and a second housing component 12 that are detachably connected to each other. Each of the first housing component 11 and the second housing component 12 extends along a longitudinal direction Y and has an open accommodating space R.

The light fixture housing 1 may be configured to be switchable between an assembled state and a transportation state.

In the assembled state, a first end 11a of the first housing component 11 along the longitudinal direction Y and a second end 12b of the second housing component 12 along the longitudinal direction Y are fixed together, and the light-emitting component 2 is received in the accommodating space R of the first housing component 11 and the second housing component 12. It should be noted here that the light-emitting component 2 may be an integrated component; in this case, the integrated light-emitting component 2 may be received in the accommodating spaces R of the assembled first housing component 11 and second housing component 12. Further, the light-emitting component 2 may be a plurality of light-emitting units which are separate and are electrically connected to each other; in this case, these light-emitting units are accommodated in respective accommodating spaces R of the first housing component 11 and the second housing component 12, and are electrically connected to each other after assembly.

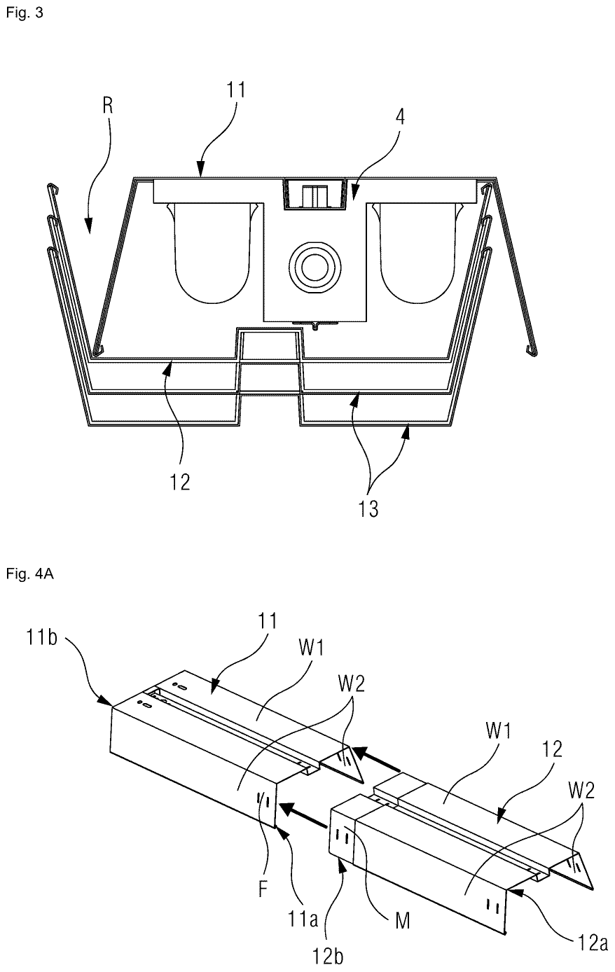

In the transportation state, the first housing component 11 and the second housing component 12 are stacked one on top of the other, and one of the first housing component 11 and the second housing component 12 is at least partially received in the accommodating space R of the other of the first housing component 11 and the second housing component 12. In particular, as shown in FIG. 3, the first housing component 11 and the second housing component 12 may be stacked together facing each other. Certainly, the stacking manner of the present application is not limited thereto. For example, the first housing component 11 and the second housing component 12 may also be stacked together in such a manner that the second housing component 12 is nested together with middle housing components 13 as shown in FIG. 3. Of course, in such a case, due to the presence of end caps 4 fixed on the first housing component 11 and the second housing component 12, the first housing component 11 and the second housing component 12 stacked together may be staggered in the longitudinal direction Y, and the end caps 4 may also be detached for independent transportation to eliminate such staggering.

In one example, each of the first housing component 11 and the second housing component 12 may comprise a top wall W1 and two side walls W2 extending from two opposite side edges of the top wall W1 in a transverse direction X perpendicular to the longitudinal direction Y, the top wall W1 and the two side walls W2 enclosing the accommodating space R; wherein the cross section perpendicular to the longitudinal direction Y of each of the first housing component 11 and the second housing component 12 may have a trapezoidal shape. Of course, the shape of the housing component of the present application is not limited thereto, and the cross section may also have other shapes, such as triangular, arc-shaped, semi-circular, etc. Here, an integrated housing wall can be included to form an arc-shaped or semi-circular cross section, or only two side walls may be included to form a cross section having a triangular shape.

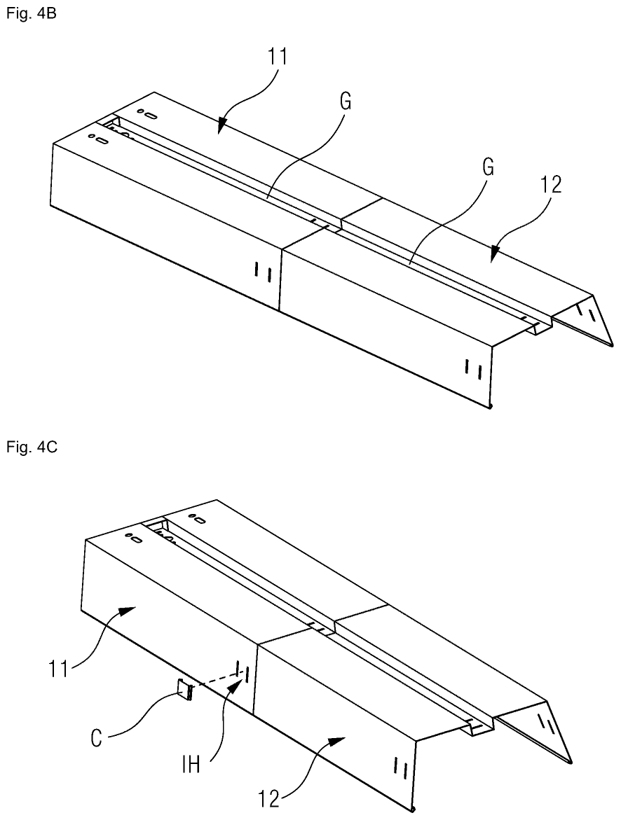

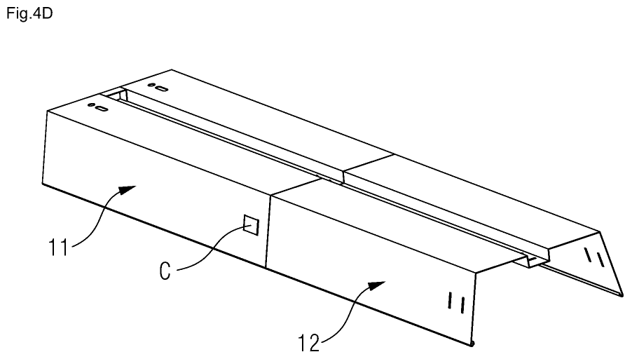

As shown in FIGS. 4A-4D, the first end 11a of the first housing component 11 may be provided with a female end connecting portion F, and the second end 12b of the second housing component 12 may be provided with a male end connecting portion M; wherein the male end connecting portion M of the second housing component 12 can be inserted into and connected to the female end connecting portion F of the first housing component 11, such that the first housing component 11 and the second housing component 12 are fixed together.

In one example, the male end connecting portion M of the second housing component 12 and the female end connecting portion F of the first housing component 11 may be fixed together by interference fit.

Alternatively or additionally, each of the male end connecting portion M of the second housing component 12 and the female end connecting portion F of the first housing component 11 may be provided with at least one insertion hole group; wherein in the assembled state, the insertion hole group of the female end connecting portion F of the first housing component 11 and the corresponding insertion hole group of the male end connecting portion M of the second housing component 12 are aligned for receiving a fixing component C, the fixing component C being inserted into the insertion hole group and the corresponding insertion hole group. The insertion hole group may be provided on the top wall W1 and/or the side walls W2. In particular, the fixing component C may be a fixing clip which has two legs to be inserted into two holes of the insertion hole group. Of course, the present application is not limited thereto, for example, as an alternative to the insertion fit of the male end connecting portion M and the female end connecting portion F, one hole may be provided at each of the first end 11a of the first housing component 11 and the second end 12b of the second housing component 12 to form an insertion hole group to receive the fixing component C.

FIGS. 4A-4D schematically show an assembly process of the first housing component 11 and the second housing component 12 of the light fixture assembly 100. As shown in FIG. 4A, the female end connecting portion F of the first housing component 11 and the male end connecting portion M of the second housing component 12 are aligned with each other to be in preparation for being inserted and connected together. As shown in FIG. 4B, the female end connecting portion F of the first housing component 11 and the male end connecting portion M of the second housing component 12 are inserted and connected together. As shown in FIG. 4C, the insertion hole group IH of the female end connecting portion F of the first housing component 11 is aligned with a corresponding insertion hole group of the male end connecting portion M of the second housing component 12 to be in preparation for insertion of the fixing component C therein. As shown in FIG. 4D, the fixing component C is inserted into the insertion hole group IH and the corresponding insertion hole group aligned with each other to achieve fixing.

The light fixture housing 1 can further comprise at least one middle housing component 13 for adapting to light-emitting components 2 with different lengths. Similarly to the first housing component 11 and the second housing component 12, the middle housing component 13 extends along the longitudinal direction Y, and may comprise a top wall W1 and two side walls W2 extending from two opposite side edges of the top wall W1 of the middle housing component 13 in the transverse direction X, the top wall W1 and the two side walls W2 of the middle housing component 13 enclosing an accommodating space R; wherein the cross section perpendicular to the longitudinal direction Y of the middle housing component 13 has a trapezoidal shape. In the assembled state, the at least one middle housing component 13 is fixed between the first housing component 11 and the second housing component 12. In the transportation state, the at least one middle housing component 13 is stacked together with the first housing component 11 and the second housing component 12. In one example, the light fixture housing 1 comprises a plurality of middle housing components 13; and in the assembled state, the plurality of middle housing components 13 are connected to one another in an end-to-end manner along the longitudinal direction Y.

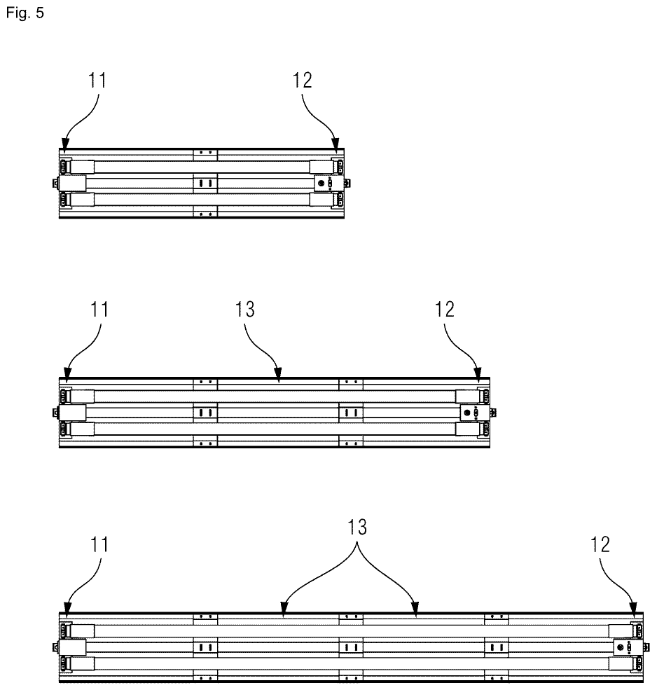

The number of the middle housing components 13 can be selected according to actual requirements. As shown in FIG. 5, there may be no middle housing component 13, there may be one middle housing component 13, or there may be multiple middle housing components 13, such as two middle housing components 13.

In particular, both ends of each middle housing component 13 in the longitudinal direction Y are respectively provided with a male end connecting portion M and a female end connecting portion F; wherein the male end connecting portion M of the middle housing component 13 is configured to be capable of fitting with the female end connecting portion F of an adjacent middle housing component 13 or fitting with the female end connecting portion F of the first housing component 11; and the female end connecting portion F of the middle housing component 13 is configured to be capable of fitting with the male end connecting portion M of an adjacent middle housing component 13 or fitting with the male end connecting portion M of the second housing component 12.

In one example, the top wall W1 of each of the first housing component 11, the second housing component 12 and the middle housing component 13 may be provided with a wiring groove G extending in the longitudinal direction Y. These wiring grooves G are in communication with each other to accommodate a lead wire LW. Accordingly, the lead wire can be hidden to improve the aesthetic appearance.

In one example, the light fixture assembly 100 can further comprise two suspension cable units 3; each suspension cable unit 3 can comprise a suspension cable 31 and a hook portion connected at the bottom end of the suspension cable 31. Each of a second end 11b of the first housing component 11 along the longitudinal direction Y and a first end 12a of the second housing component 12 along the longitudinal direction Y is provided with a hook hole group for fitting with respective hook portion.

In particular, each hook portion may comprise two hooks 32, and each hook hole group comprises two hook holes H spaced apart along the transverse direction X.

In one example, the light-emitting component 2 may comprise at least one light tube 21 (e.g. two light tubes) extending along the longitudinal direction Y, for example a type-B light fixture.

In one example, the light fixture assembly 100 can further comprise an end cap unit, the end cap unit comprising two end caps 4; the two end caps 4 are fixed respectively at the second end 11b of the first housing component 11 along the longitudinal direction Y and the first end 12a of the second housing component 12 along the longitudinal direction Y, and are located in the accommodating space R of the first housing component 11 and the second housing component 12.

Each end cap 4 may comprise an end cap body 41, and at least one socket portion 42 fixed on the end cap body 41 and for receiving and being electrically connected to two plugs 21a provided at one end of the light tube 21. The end cap unit is configured to selectively allow one or both of the two plugs 21a fitting with one end cap 4 of the two end caps 4 to be connected to a live wire, and the end cap unit is configured to allow two plugs 21a fitting with the other end cap 4 of the two end caps 4 to be connected to a null wire.

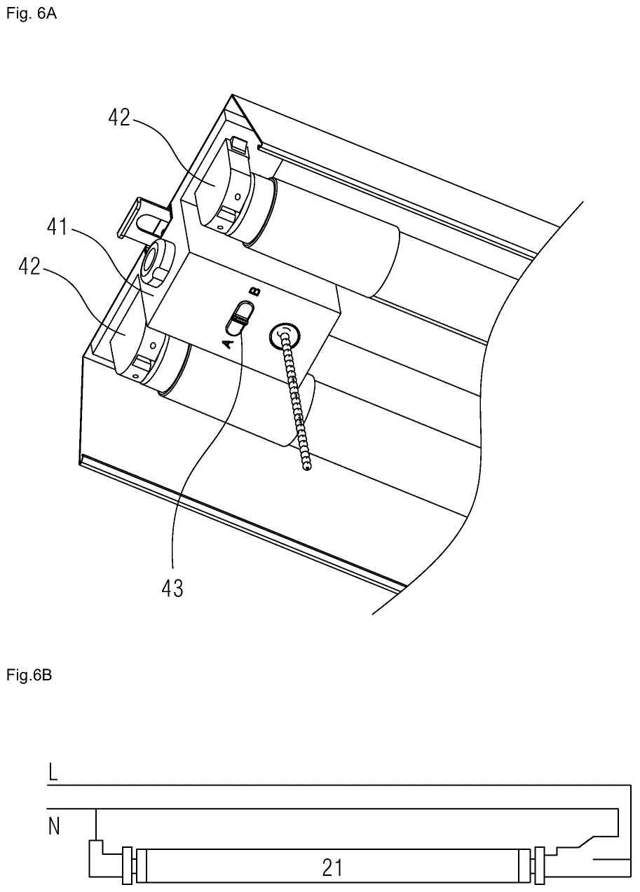

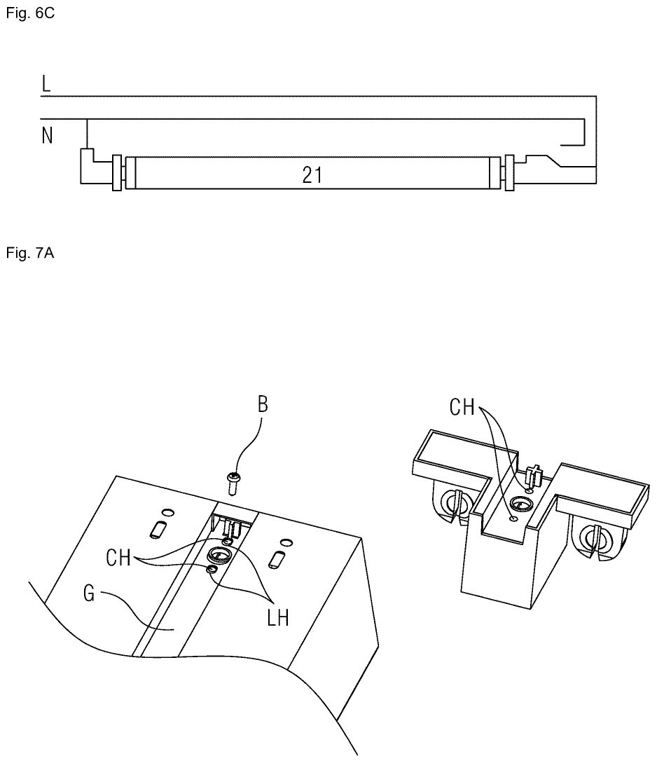

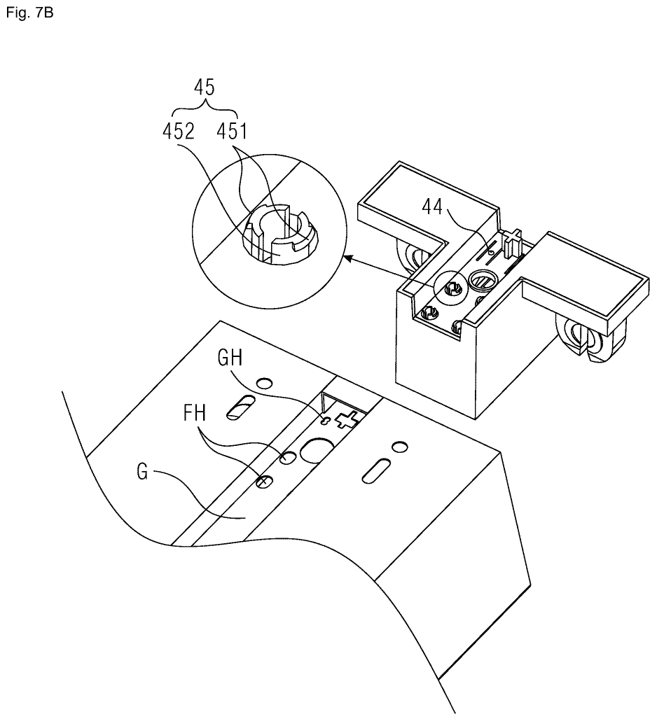

In one example, as shown in FIGS. 6A-6C, the end cap unit may further comprise a switch 43 provided on the one end cap 4, the switch 43 being configured to be switchable between a first position and a second position. When the switch 43 is located at the first position, both the two plugs 21a fitting with the one end cap 4 are connected to the live wire; and when the switch 43 is located at the second position, one of the two plugs 21a fitting with the one end cap 4 is connected to the null wire and the other is connected to the live wire.

In one example, each end cap 4 may be configured to be fixed at the second end 11b of the first housing component 11 or the first end 12a of the second housing component 12 in such a manner that the end cap can be displaced along the longitudinal direction Y. Accordingly, process errors of the light-emitting component can be adapted through fine adjustment. In particular, the distance by which the end cap 4 can be displaced along the longitudinal direction Y can be in a range of 0 and 3 mm.

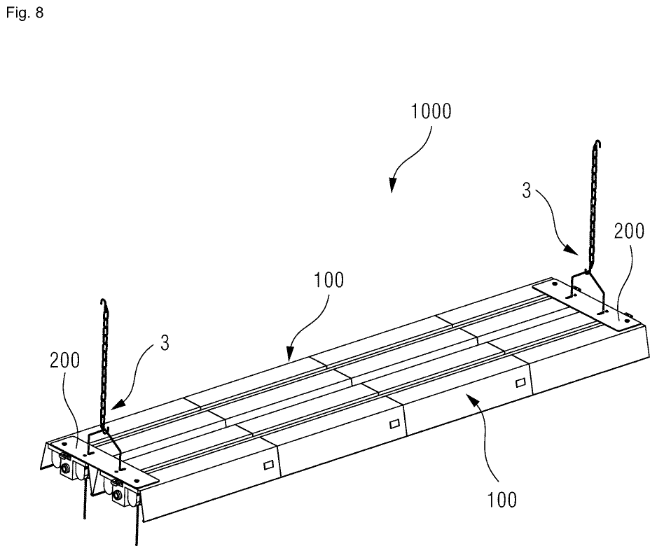

In particular, as shown in FIG. 7A, the top of the end cap 4 may be provided with at least one circular screw hole CH, and the top wall W1 of the first housing component 11 or the second housing component 12 may be provided with at least one long hole LH, the long hole LH being aligned with the corresponding circular screw hole CH. The length of the long hole LH along the longitudinal direction Y is larger than the width of the long hole LH along the transverse direction X, and the width of the long hole LH is greater than or equal to the diameter of the circular screw hole CH. A bolt B can pass through the long hole LH and then is screwed into the circular screw hole CH, to fix the end cap 4 to the first housing component 11 or the second housing component 12. This can facilitate fine adjustment of the position of the end cap.

Further, the top wall W1 of each of the first housing component 11 and the second housing component 12 is provided with the wiring groove G extending in the longitudinal direction Y, the long hole LH being located in the wiring groove G. Accordingly, the aesthetic appearance can be improved and the mounting of the light fixture housing can be facilitated.

Alternatively, as shown in FIG. 7B, the top of the end cap 4 may be provided with at least one cylindrical elastic arm 44 extending perpendicular to the longitudinal direction Y and the transverse direction X, and at least one gourd-shaped hole GH may be provided on the top wall W1 of the first housing component 11 or the second housing component 12, wherein the gourd-shaped hole GH comprises two circular holes arranged along the longitudinal direction Y and partially overlapping with each other. The cylindrical elastic arm 44 is configured to be selectively snap-fit in either one of the two circular holes of the corresponding gourd-shaped hole GH. This can facilitate fine adjustment of the position of the end cap.

In particular, the top of the end cap 4 may also be provided with at least one upright column 45; the upright column 45 comprises an upright column body 451 extending perpendicular to the longitudinal direction Y and the transverse direction X, and at least one fastening portion 452 extending from the top of the upright column body 451 and perpendicular to the upright column body 451, and at least one fastening hole FH may be provided on the top wall W1 of the first housing component 11 or the second housing component 12. The upright column 45 is configured such that the upright column body 451 can pass through the corresponding fastening hole FH, and such that the top wall W1 of the first housing component 11 or the second housing component 12 can be fastened between the fastening portion 452 and the top of the end cap 4. Accordingly, secure connection can be ensured.

Further, the top wall W1 of each of the first housing component 11 and the second housing component 12 is provided with the wiring groove G extending in the longitudinal direction Y; the gourd-shaped hole GH and the fastening hole FH can be located in the wiring groove G. Accordingly, the aesthetic appearance can be improved and the mounting of the light fixture housing can be facilitated.

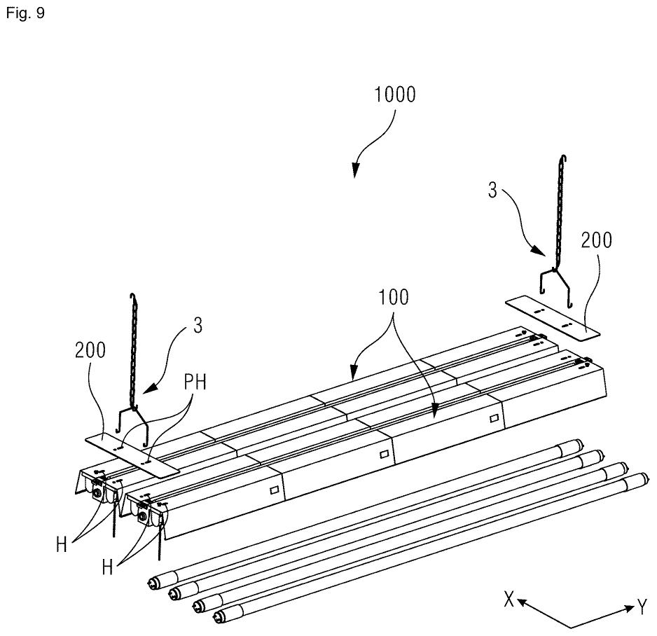

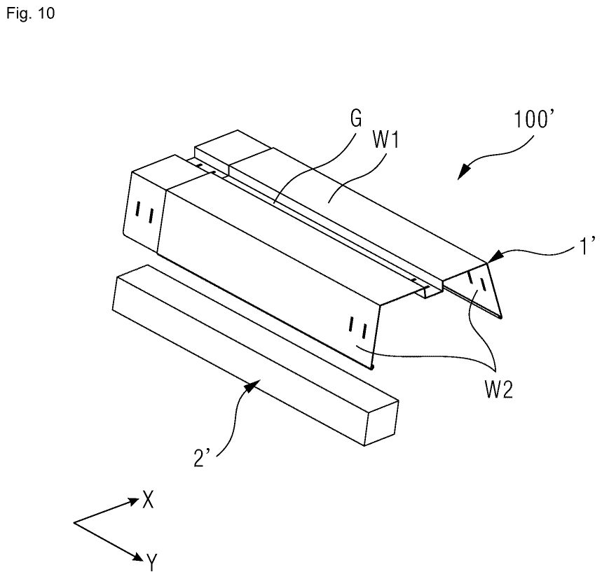

The present application also proposes a light fixture system 1000. As shown in FIGS. 8 and 9, the light fixture system 1000 may generally comprise a plurality of light fixture assemblies 100 and two connecting plates 200. The plurality of light fixture assemblies 100 are arranged side by side along a transverse direction X. The two connecting plates 200 extend along the transverse direction X, one of the two connecting plates 200 connects the first housing components 11 of the plurality of light fixture assemblies 100 together, and the other of the two connecting plates 200 connects the second housing components 12 of the plurality of light fixture assemblies 100 together. For example, the connecting plates 200 may connect the plurality of light fixture assemblies 100 together via a plurality of fixing bolts.

In particular, the light fixture system 1000 can further comprise a plurality of suspension cable unit groups, each suspension cable unit group comprising two suspension cable units 3; each suspension cable unit 3 comprises a suspension cable 31 and a hook portion connected at the bottom end of the suspension cable 31, and each hook portion comprising two hooks 32. Each of a second end 11b of the first housing component 11 along the longitudinal direction Y and a first end 12a of the second housing component 12 along the longitudinal direction Y is provided with a hook hole group, each hook hole group comprising two hook holes H spaced apart along the transverse direction X. Each connecting plate 200 may be provided with at least one pass-through hole group, each pass-through hole group comprising two pass-through holes PH.

The number of the suspension cable unit groups may be the same as the number of the pass-through hole groups, and may be one less than the number of the light fixture assemblies 100. One hook 32 of the two hooks 32 of the hook portion of each suspension cable unit 3 is configured to be capable of passing through one pass-through hole PH of the pass-through hole group and then being hooked to one hook hole H of the two hook holes H of the hook hole group of the first housing component 11 or the second housing component 12 of a light fixture assembly 100; and the other hook 32 of the two hooks 32 of the hook portion of each suspension cable unit 3 is configured to be capable of passing through the other pass-through hole PH of the pass-through hole group and then being hooked to one hook hole H of the two hook holes H of the hook hole group of the first housing component 11 or the second housing component 12 of an adjacent light fixture assembly 100.

The present application further provides a light fixture module 100′. As shown in FIG. 10, the light fixture module 100′ can generally comprise a housing unit 1′ and a light-emitting unit 2′ removably connected to the housing unit 1′. The housing unit 1′ extends in a longitudinal direction Y, and has an open accommodating space R.

The light fixture module 100′ may be configured to be switchable between an assembled state and a transportation state.

In the assembled state, the light fixture module 100′ may be connected together with other light fixture modules 100′ along the longitudinal direction Y and/or a transverse direction X, and the light-emitting unit 2′ is received in the accommodating space R of the housing unit 1′ and electrically connected to the light-emitting units 2′ of the other light fixture modules 100′.

In the transportation state, the housing unit 1′ of the light fixture module 100′ and the housing units 1′ of the other light fixture modules 100′ are stacked one on top of the other, and the housing unit 1′ of the light fixture module 100′ is at least partially received in the accommodating space R of the housing unit 1′ of the other light fixture module 100′.

The content above merely relates to preferred embodiments of the present application and is not intended to limit the present application. For a person skilled in the art, the present application may have various modifications and variations. Any modifications, equivalent replacements, improvements, etc. made within the spirit and principle of the present application shall all belong to the scope of protection of the present application.

1. A light fixture assembly, comprising:
a light fixture housing; and
a light-emitting component being removably connected to the light fixture housing, wherein
the light fixture housing comprises a first housing component and a second housing component that are detachably connected to each other, each of the first housing component and the second housing component extends along a longitudinal direction and has an open accommodating space;
the light fixture housing is configured to be switchable between an assembled state and a transportation state;
in the assembled state, a first end of the first housing component along the longitudinal direction and a second end of the second housing component along the longitudinal direction are fixed together, and the light-emitting component is received in the accommodating spaces of the first housing component and the second housing component; and
in the transportation state, the first housing component and the second housing component are stacked one on top of the other, and one of the first housing component and the second housing component is at least partially received in the accommodating space of the other of the first housing component and the second housing component.

2. The light fixture assembly according to claim 1, wherein each of the first housing component and the second housing component comprises a top wall and two side walls extending from two opposite side edges of the top wall in a transverse direction perpendicular to the longitudinal direction, the top wall and the two side walls enclosing the accommodating space; wherein the cross section perpendicular to the longitudinal direction of each of the first housing component and the second housing component has a trapezoidal shape.

3. The light fixture assembly according to claim 1, wherein the first end of the first housing component is provided with a female end connecting portion, and the second end of the second housing component is provided with a male end connecting portion; wherein the male end connecting portion of the second housing component can be inserted into and connected to the female end connecting portion of the first housing component, such that the first housing component and the second housing component are fixed together.

4. The light fixture assembly according to claim 3, wherein each of the male end connecting portion of the second housing component and the female end connecting portion of the first housing component is provided with at least one insertion hole group; wherein in the assembled state, the insertion hole group of the female end connecting portion of the first housing component and the corresponding insertion hole group of the male end connecting portion of the second housing component are aligned for receiving a fixing component, the fixing component being inserted into the insertion hole group and the corresponding insertion hole group.

5. The light fixture assembly according to claim 1, wherein the light fixture housing further comprises at least one middle housing component for adapting to light-emitting components with different lengths.

6. The light fixture assembly according to claim 5, wherein the middle housing component extends along the longitudinal direction, and comprises a top wall and two side walls extending from two opposite side edges of the top wall of the middle housing component in the transverse direction, the top wall and the two side walls of the middle housing component enclosing an accommodating space; wherein the cross section perpendicular to the longitudinal direction of the middle housing component has a trapezoidal shape.

7. The light fixture assembly according to claim 6, wherein
in the assembled state, the at least one middle housing component is fixed between the first housing component and the second housing component; and
in the transportation state, the at least one middle housing component is stacked together with the first housing component and the second housing component.

8. The light fixture assembly according to claim 5, wherein the light fixture housing comprises a plurality of middle housing components, and in the assembled state, the plurality of the middle housing components are connected to one other in an end-to-end manner along the longitudinal direction.

9. The light fixture assembly according to claim 5, wherein both ends of each middle housing component in the longitudinal direction are respectively provided with a male end connecting portion and a female end connecting portion; wherein the male end connecting portion of the middle housing component is configured to be capable of fitting with the female end connecting portion of an adjacent middle housing component or fitting with the female end connecting portion of the first housing component; and the female end connecting portion of the middle housing component is configured to be capable of fitting with the male end connecting portion of an adjacent middle housing component or fitting with the male end connecting portion of the second housing component.

10. The light fixture assembly according to claim 1, wherein the light fixture assembly further comprises two suspension cable units; each suspension cable unit comprises a suspension cable and a hook portion connected at the bottom end of the suspension cable;
each of a second end of the first housing component along the longitudinal direction and a first end of the second housing component along the longitudinal direction is provided with a hook hole group for fitting with respective hook portion.

11. The light fixture assembly according to claim 10, wherein each hook portion comprises two hooks; and
each hook hole group comprises two hook holes spaced apart along the transverse direction.

12. The light fixture assembly according to claim 1, wherein the light-emitting component comprises at least one light tube extending along the longitudinal direction.

13. The light fixture assembly according to claim 12, wherein the light fixture assembly further comprises an end cap unit, the end cap unit comprising two end caps; the two end caps are fixed respectively at the second end of the first housing component along the longitudinal direction and the first end of the second housing component along the longitudinal direction, and are located in the accommodating spaces of the first housing component and the second housing component;
each end cap comprises an end cap body, and at least one socket portion fixed on the end cap body and for receiving and being electrically connected to two plugs provided at one end of the light tube;
wherein the end cap unit is configured to selectively allow one or both of the two plugs fitting with one end cap of the two end caps to be connected to a live wire, and the end cap unit is configured to allow two plugs fitting with the other end cap of the two end caps to be connected to a null wire.

14. The light fixture assembly according to claim 13, wherein the end cap unit further comprises a switch provided on the one end cap, the switch being configured to be switchable between a first position and a second position;
when the switch is located at the first position, both the two plugs (21a) fitting with the one end cap (4) are connected to the live wire; and
when the switch (43) is located at the second position, one of the two plugs (21a) fitting with the one end cap (4) is connected to the null wire and the other is connected to the live wire.

15. A light fixture system, comprising:
a plurality of light fixture assemblies according to claim 2, the plurality of light fixture assemblies being arranged side by side along a transverse direction; and
two connecting plates extending along the transverse direction, wherein one of the two connecting plates connects the first housing components of the plurality of light fixture assemblies together, and the other of the two connecting plates connects the second housing components of the plurality of light fixture assemblies together.

16. The light fixture system according to claim 15, wherein the light fixture system further comprises a plurality of suspension cable unit groups, each suspension cable unit group comprising two suspension cable units; each suspension cable unit comprises a suspension cable and a hook portion connected at the bottom end of the suspension cable, and each hook portion comprising two hooks;
each of a second end of the first housing component along a longitudinal direction and a first end of the second housing component along the longitudinal direction is provided with a hook hole group, each hook hole group comprising two hook holes spaced apart along the transverse direction;
wherein each connecting plate is provided with at least one pass-through hole group, each pass-through hole group comprising two pass-through holes;
wherein the number of the suspension cable unit groups is the same as the number of the pass-through hole groups, and is one less than the number of the light fixture assemblies; and
wherein one hook of the two hooks of the hook portion of each suspension cable unit is configured to be capable of passing through one pass-through hole of the pass-through hole group and then being hooked to one hook hole of the two hook holes of the hook hole group of the first housing component or the second housing component of the light fixture assembly;
and the other hook of the two hooks of the hook portion of each suspension cable unit is configured to be capable of passing through the other pass-through hole of the pass-through hole group and then being hooked to one hook hole of the two hook holes of the hook hole group of the first housing component or the second housing component of an adjacent light fixture assembly.

17. A light fixture module, comprising:
a housing unit extending in a longitudinal direction and having an open accommodating space; and
a light-emitting unit being removably connected to the housing unit;
wherein the light fixture module is configured to be switchable between an assembled state and a transportation state;
in the assembled state, the light fixture module is connected together with other light fixture modules along the longitudinal direction and/or a transverse direction, and the light-emitting unit is received in the accommodating space of the housing unit and electrically connected to the light-emitting unit of the other light fixture module; and
in the transportation state, the housing unit of the light fixture module and the housing units of the other light fixture modules are stacked one on top of the other, and the housing unit of the light fixture module is at least partially received in the accommodating space of the housing unit of the other light fixture module.
